(19) United States
(12) Patent Application Publication
(10) Pub. No.: US 2014/0132412 A1
(43) Pub. Date: May 15, 2014

(54) WI-FI TRACKER SYSTEM FOR PERSONS AND OBJECTS

(71) Applicants: Juan José DECO, Dina Huapi (AR); Alejandro PERMINGEAT, Teodelina (AR)

(72) Inventors: Juan José DECO, Dina Huapi (AR); Alejandro PERMINGEAT, Teodelina (AR)

(21) Appl. No.: 13/972,633

(22) Filed: Aug. 21, 2013

(30) Foreign Application Priority Data
Sep. 7, 2012 (AR) 2012 0103316

(51) Int. Cl. H04W 4/02; G08B 21/18

(52) U.S. Cl. CPC H04W 4/02; G08B 21/182
USPC 340/539.13

(57) ABSTRACT

The present invention refers to a new short-distance tracking system for persons or objects consisting in the use of a Wi-Fi—emitting device (for example a key fob) carried by the person or object to be tracked, and the Wi-Fi receptor of a smart mobile phone as tracker unit. Smartphones have a function capable of measuring the intensity of a received Wi-Fi signal. The signal transmitted by the device has a constant intensity and frequencies within the range established by protocol IEEE 802.11 b/g/n (Wi-Fi), and is identified by a unique SSID. In this way the application running on the mobile phone can show the distance of the specific device emitting the wireless signal (for example, a key fob), depending on the detected attenuation level. When distance increases, the signal will show an attenuation and the application running on the phone will prompt the user to move towards the direction in which the signal intensifies. As the mobile phone approaches the device, the signal will intensify and the application will prompt the user to continue moving in the same direction.

This application claims benefit of Serial No. 2012 0103316, filed 7 Sep. 2012 in Argentina and which application is incorporated herein by reference. To the extent appropriate, a claim of priority is made to the above disclosed application.

### BACKGROUND OF THE INVENTION

The present invention refers to a new short-distance tracking system for persons and objects. The system comprises the use of a device, for example in the form of a key fob, emitting a 2.4 GHz electromagnetic signal which partially implements the IEEE 802.11 b/g/n protocol, Ad-hoc mode of operation, (said device being carried by the person or object to be tracked). The signal is received through the Wi-Fi receptor of a mobile phone operating as a tracking unit.

Tracking systems of persons and objects are comprised of three elements:
an object being tracked
a tracker element
an assembly formed by the tracks (or footprints) to be followed

Both the object being tracked and the tracker unit may be in motion during the tracking process, which causes the distance between them to increase and/or decrease as the tracker unit follows the signal generated by the tracked object. The purpose of the tracking system is to assist the operator in reducing the distance between the tracking unit and the object. A tracking process ends when the tracker system reaches the position of the tracked object.

An essential requirement for an object to be traceable is that it should generate signals that can be detected by the tracker unit. Frequently, users of known tracking systems meet the difficulty of having to use a specially designed device to perform the specific tracking functions. The need to count with these specific tracking devices discourages many users.

The aim of this invention is to enable the use of devices that are widely used by the population in their daily activities to perform a tracking process by using their basic functionalities in a non-conventional manner.

### SUMMARY OF THE INVENTION

The proposed objectives were reached through the development of a tracking system using smart mobile phones (extensively used by the population) and WI-FI emitting key fobs. Although ordinary elements, such as conventional key fobs do not have this functionality, they may be easily replaced, for example by Wi-Fi emitting key fobs, since the use of key chains is widely spread among the population.

An important feature of the system of the invention is the use of Wi-Fi signals, which are supported by most smartphones, for the tracking process. Smartphones have the functionality of measuring the intensity of received Wi-Fi signals. On the basis of this capability, the system of the invention discloses a device, for example a key fob, which emits electromagnetic signals with frequencies within the range established by the IEEE 802.11 b/g/n (Wi-Fi) standard, i.e., 2.4 GHz frequencies. The device implements the IEEE 802.11 b/g/n Ad-hoc mode of operation (Independent Basic Service Set—IBSS) but only runs the section of the protocol in which the device identifies itself by means of its SSID (Service Set IDentifier). In this way, it is possible for the application running on the mobile phone to establish the distance between the device emitting the wireless signal and the mobile phone, on the basis of the level of attenuation of the received signal. The mobile phone identifies the tracked device among all the Wi-Fi signals within its range by means of protocol 802.11 b/g/n because all the sent or received data packets have a field called SSID y and emitting device has a unique SSID.

The mobile phone runs an application that assists the user in the tracking process. When the user holding the phone moves in a certain direction, the signal received from the device will become stronger or weaker depending on the distance from the user to the tracked object (for example, a key fob). The application uses the phone's Wi-Fi- reception system to determine if the tracker unit and the tracked object are getting apart (the signal attenuates) or closer (the signal intensifies). The software also displays a visual indication (on the phone's screen) and produces a sound (through the phone speakers) to let the user know the distance between the mobile phone and the Wi-fi-transmitter and whether it is increasing or decreasing. With these indications, the person tracking using a mobile phone during the tracking process, will be guided in the right direction to find the object or person (carrying for example a key fob).

### BRIEF DESCRIPTION OF THE DRAWINGS

FIG. 1—Diagram of operation of the tracking system;

FIG. 2—Block diagram of the Wi-Fi signal emitting device (key fob); and

FIG. 3—Flow diagram of the application running on the mobile phone.

### DETAILED DESCRIPTION

As used herein, SSID (Service Set IDentifier) is a name included in all packets of a wireless network (Wi-Fi) which identifies each packet as part of that specific network. The SSID transmitted by a tracked unit (for example a key fob) is unique and is used by the application running within the mobile phone to distinguish one specific device from the others.

As used herein, dBm is defined as the power ratio in decibels (dB) of the measured power referenced to one milliwatt (mW).

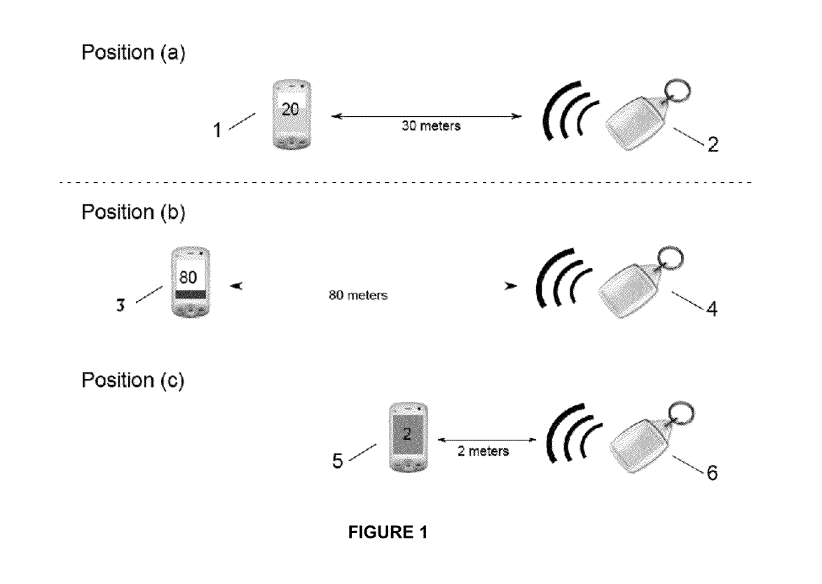

FIG. 1 shows three different steps in the tracking process. During the three steps, a tracker application runs on the mobile phone to search a Wi-Fi emitting device (for example, a key fob).

At position (a) the application running on the mobile phone (symbol 1) displays number 30 and an orange bar that covers 60% of the total size of the screen, which means that the signal received from the key fob (symbol 2) is relatively strong. Number 30 means that the phone is at a distance of approximately 30 meters from the key fob. In addition, a pulsing sound signal of 5 tenths of a second is emitted by the application through the mobile phone speakers. At position (b) the mobile phone has been moved away from the key fob, and now the application running on the mobile phone (symbol 3) displays a value of 80 and a red bar that covers 10% of the screen, which means that the signal transmitted by the key fob device (symbol 4) is weak and a value of 80 means that the mobile phone is approximately 80 meters away from the key fob. In addition, a pulsing sound signal of 10 tenths of a second is emitted by the application through the mobile phone speakers.

At position (c) the mobile phone has been moved towards the device, which is now much nearer than at position (a), and the application running on the mobile phone (symbol 5) displays a value of 2 and a green bar covering 100% of the screen, which means that the signal received from the device (symbol 6) is very strong. A number 2 in the display means that the mobile phone is approximately 2 meters away from the device. In addition, the application will produce a pulsing sound signal with pulses every 2 tenths of a second.

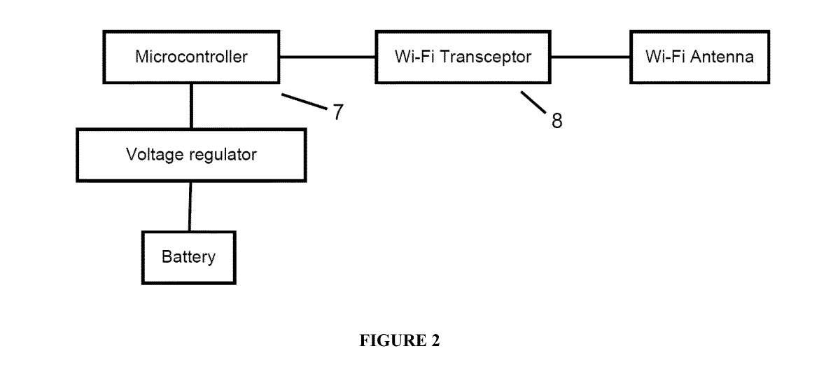

FIG. 2 shows a block diagram of the system comprising the emitting device (for example, a key fob). The microcontroller (symbol 7) runs an application that sends the SSID over the Wi-Fi transceptor (symbol 8) every n seconds (which switches-on the Wi-Fi transceptor before sending a message with the SSID and switches it off after the message has been sent), where n is configurable. In this way the system saves a great amount of power. Each device transmits a single SSID that matches its serial number.

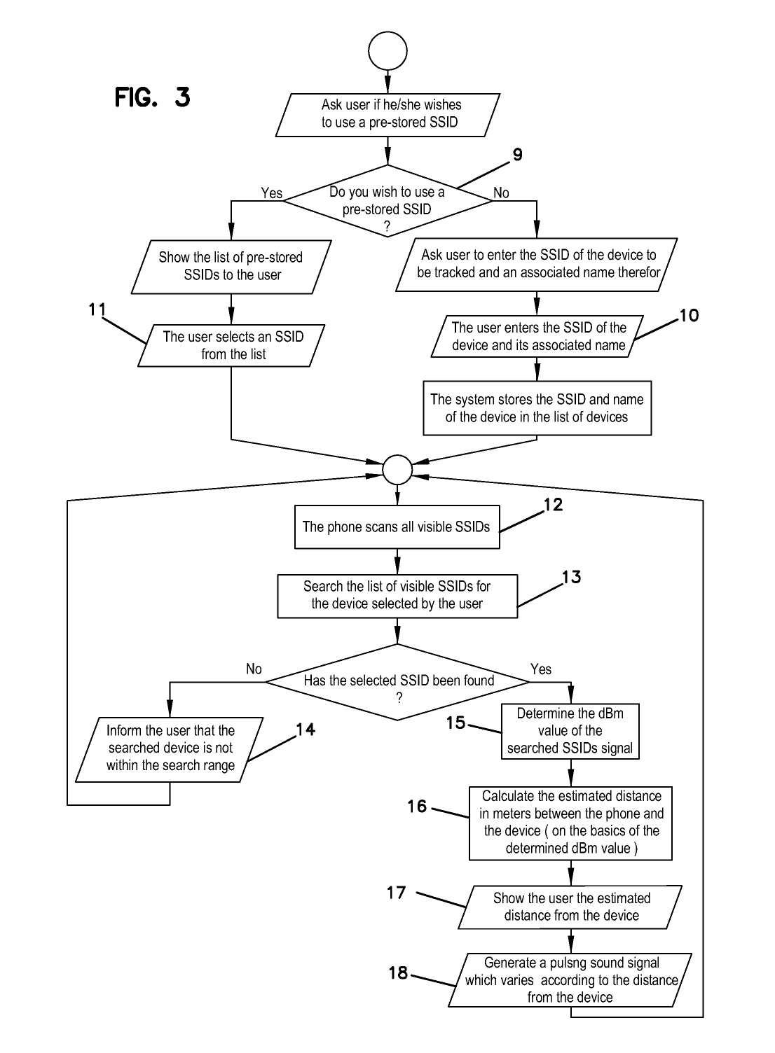

FIG. 3 shows a flow diagram representing the behavior of the software (application) that runs on the mobile phone used for the tracking process. The application has a list of associated devices (the list contains an SSID and a name for each device). To start the process, the user is inquired (numeral 9) if he/she wishes to track a pre-stored device or a device previously tracked with that phone. In the latter case, the user should enter the SSID of the new device and provide a representative name for the device (for example a key fob), like “car keys” or “device attached to Jimmy's jeans (numeral 10). If the user wishes to track a device that has been previously used by the same mobile phone (symbol 11), the name of the device can be selected from the list of names shown in the display, which links each name to a respective SSID. The application then scans all the Wi-Fi networks within its reach (numeral 12). Once the scanning of the available Wi-Fi networks has been completed, the application searches the SSID of the tracked device (numeral 13). If the SSID of the device to be tracked is not present among the detectable signals, the user is informed that the device is not within the range of coverage of the receptor (numeral 14). If, on the contrary, the SSID of the device is detected among the available networks, the system determines the attenuation of the signal, measured in dBm related to the SSID of the device (numeral 15). As the dBm value of the signal as emitted by the device is known as constant, it is possible to calculate the distance at which the device is located in relation to the mobile phone (numeral 16) on the basis of the attenuation of the signal caused by distance. Once an estimation of distance of the device has been obtained, the user is shown, on the phone display (numeral 17) a number that indicates the estimated distance in meters, and a bar extending in a proportional percentage (in relation to its full length) of the total measurable distance. The bar will be red if the device is at a distance exceeding 85% of the total measurable distance, it will be orange-colored if is from 85 to 25% away, and green if less than 25% of the total measurable distance. In addition to the display, the software emits a pulsing sound signal (numeral 18), with shorter intervals between pulses if the distance between the mobile phone and the device is short, and longer intervals if the distance between the mobile phone and the device is long. The application then repeats the cycle starting from the Wi-Fi network-scanning step (numeral 12).

We claim:

1. A tracker system for persons and objects comprising the use of the attenuation level of an electromagnetic signal in the 2.4 GHz frequency and communication protocol IEEE 802.11 b/g/n (Ad-hoc operation mode) for measuring the distance between a tracker and a moving object to be tracked.

2. A tracker system for persons and objects according to claim 1 wherein the moving object to be tracked may be a person or an object carrying a device (for example a key fob) emitting identity information using the protocol IEEE 802.11 b/g/n, Ad-hoc mode of operation, which identifies a device by transmitting its SSID.

3. A tracker system for persons and objects according to claim 2 wherein the device carried by the person or object to be tracked transmits a signal at a constant level once every n seconds in order to save power, where n is adjustable.

4. A tracker system for persons and objects according to claim 1 wherein the tracker element is a mobile phone with Wi-Fi capabilities running an application that senses the signal transmitted by the Wi-Fi signal-emitting mobile device having the SSID of the tracked object.

5. A tracker system for persons and objects according to claim 1 wherein the application running on the mobile phone shows in three different ways the estimated distance between the mobile phone and the tracked Wi-Fi signal-emitting mobile device:
by emitting a pulsing sound signal, with short time intervals if the distance between the mobile phone and the Wi-Fi signal-emitting mobile device is short, and with long time intervals if the distance between the mobile phone and the Wi-Fi signal-emitting mobile device is long;
by displaying on the screen a number indicating the estimated distance in meters between the mobile phone and the Wi-Fi signal-emitting mobile device and
by displaying on the screen a bar of varying length (as compared to its full length) that corresponds to a proportional percentage of the distance between the mobile phone and the Wi-Fi signal-emitting mobile device, said bar being red if the distance is more than 85% of the total measurable distance, orange if the distance is from 85% to 25% of the total measurable distance, and green if the distance is less than 25% of the total measurable distance.
